(19) United States
(12) Patent Application Publication
(10) Pub. No.: US 2002/0023052 A1
(43) Pub. Date: Feb. 21, 2002

(54) Reduced-risk agricultural transactions

(76) Inventors: Frank Remley, Lakeville, MN (US); Richard McLellan, Eden Prairie, MN (US); Dennis Inman, Eden Prairie, MN (US); Dean Grossmann, Plymouth, MN (US); Donald Roper, Chaska, MN (US); Michael Hofer, Hutchinson, MN (US)

Correspondence Address: SHUMAKER & SIEFFERT, P. A., 150 GATEWAY CORPORATE CENTER 1, 576 BIELENBERG DR., ST. PAUL, MN, 55125, US

(21) Appl. No.: 09/802,325

(22) Filed: Mar. 8, 2001

Related U.S. Application Data
(60) Provisional application No. 60/187,741, filed on Mar. 8, 2000.

(51) Int. Cl. G06F 17/60

(52) U.S. Cl. 705/38

(57) ABSTRACT

A method for transacting exchanges of agricultural products provides an agricultural producer with a guaranteed level of revenue. With guaranteed revenue, the producer greatly reduces the risks associated with the agriculture business, and obtains both yield and price protection. In exchange for the guaranteed level of revenue, the producer agrees to several conditions designed to provide value to the guarantor and reduce the guarantor's risk. In this manner, the guarantor and producer both benefit from practice of the method. The producer may agree to deliver all or a portion of its output, for example, to an outlet specified by the guarantor. In addition, the producer may agree to purchase all or a portion of its agricultural inputs, e.g., seeds, fertilizer, and agricultural chemicals, from a source specified by the guarantor. The producer also may agree to a number of producing conditions designed to maximize yield and marketability, such as the use of particular hybrids and pesticides. Further, the producer may agree to provide the guarantor with output information, such as crop growth status, to better inform the guarantor and help it manage its risk.

This application claims priority from U.S. application Ser. No. 60/187,741, filed Mar. 8, 2000, the entire content of which is incorporated herein by reference.

### TECHNICAL FIELD

The present invention relates to the agriculture business and, more particularly, to transactions involving the production and delivery of agricultural products.

### BACKGROUND

Agricultural producers face substantial risks in producing an agricultural product, bringing it to market, and earning a profit. Individual farmers, for example, are especially susceptible to risk factors that can adversely affect yield, marketability, and market price. Risk factors include weather conditions such as drought, hail, wind, frost, and excess rain, plant disease, insects, market volatility, increased global capacity, and government regulations. To offset some of the risks, many farmers purchase crop insurance either from private carriers or through federally sponsored programs. In the United States, for example, federally sponsored Crop Revenue Coverage insures the farmer for yield and revenue, but is very expensive and provides insurance levels that are generally inadequate. Consequently, many farmers forego crop insurance altogether, making them vulnerable to risks that can cut into profits and even drive them out of business.

### SUMMARY

The present invention is directed to a method for transacting exchanges of agricultural products such as crops with reduced risk to the producer. The method provides the agricultural producer with a guaranteed revenue adjustment that offers both yield and price protection in the event yield or market conditions fall below expectations. With a guaranteed revenue adjustment, the producer can reduce the risks associated with the agriculture business. In exchange for the guaranteed revenue adjustment, the producer agrees to several conditions designed to provide value to the guarantor who offers the revenue adjustment, and thereby reduce the guarantor's risk in the agricultural marketplace. In this manner, the guarantor and producer both benefit from the arrangement for revenue adjustment.

The guaranteed revenue adjustment can be provided for a given contract period according to a number of different calculation scenarios. The contract period ordinarily will correspond to a particular harvest period and, in most cases, will be a year. In general, the revenue adjustment can be applied to the actual value marketed by the producer, and calculated as the difference between a target value and a benchmark value. The target value can be based on the product of a target yield and a target price. The target yield may be agreed upon based on a percentage of average production history (APH) yield, historical yield, or expected yield. With appropriate risk management steps, as contemplated herein, the percentage could be on the order of 85-95%. This range is exemplary only and should not be considered limiting of the invention as broadly embodied herein. The target price can be a futures price for the particular agricultural output, as agreed upon by the producer and guarantor.

The benchmark value can be based on the product of actual yield for the given contract period and a benchmark price. The actual yield is the yield delivered by the producer to the guarantor or a designee for the contract period. The benchmark price, like the target price, can be a futures price set by the producer or agreed upon by the producer and guarantor. If actual yield is less than the target yield and/or benchmark price is less than the target price, the difference between target value and benchmark value will provide a revenue adjustment to the producer. The revenue adjustment is added to the actual value, i.e., the product of actual yield and the actual price marketed by the producer, to provide an overall contract value. The resulting contract value incorporates guaranteed yield and price protection, although the amount is variable. The yield and price protection helps reduce the producer's risk.

In exchange for the guaranteed revenue adjustment and reduced risk, the producer may agree to deliver all or a portion of its output, for example, to the guarantor or an outlet specified by the guarantor. In addition, the producer may agree to purchase all or a portion of its agricultural inputs, e.g., seeds, fertilizer, and agricultural chemicals, from the guarantor or a source specified by the guarantor. The producer also may agree to an agronomic plan that specifies a number of production conditions designed to maximize yield and marketability, such as the use of particular hybrid seed and pesticide combinations. Further, the producer may agree to provide the guarantor with output status information, such as crop growth status, soil conditions, and data concerning crop damage due to weather, pests, or disease, to better inform the guarantor and help it manage its risk in making agricultural trading decisions. To aid in gathering of output status information, the producer may permit crop scouting visits by persons designated by the guarantor.

The above conditions enable the guarantor to better manage its risk, and thereby provide a target value that is based on a relatively high percentage of expected yield, APH, or historical yield. The guarantor may act as the source of inputs, the recipient of information, and the outlet for outputs produced by the agricultural producer. In this way, the guarantor benefits from added revenue, improved market intelligence, and a dependable supply of outputs. Alternatively, the guarantor may specify one or more agents to fulfill particular roles. For example, the guarantor may direct the producer to purchase inputs from particular retailers and deliver outputs to particular processors. In each case, the producer and guarantor both benefit, providing a more robust agricultural supply chain that is more resistant, both at the producer and processor level, to risk factors associated with the agriculture business.

In general, one or more of the above conditions can have the combined effect of enabling the guarantor to originate more outputs, sell more inputs, and build better relationships with producers and retailers. At the same time, retailers involved in the arrangement may increase product sales with current customers, generate new customers, and increase customer loyalty. The producer may benefit from reduced risk and sound agronomic advice designed to increase yield.

In some embodiments, the guarantor and producer may agree to place a limit on the revenue adjustment available to the producer. In this manner, the revenue adjustment can be focused on the revenue that is ordinarily most critical to farming profitability. Producers usually do not experience revenue decreases of more than twenty-five percent. Many producers may experience, however, revenue decreases in the range of ten to twenty percent. In this “working layer” of revenue, the producer's income is most vulnerable. Thus, a revenue adjustment provided in accordance with the invention can be more narrowly tailored to address this concern, while limiting the guarantor's liability. For example, the revenue adjustment may protect a certain percentage of the producer's historic value.

In one embodiment, the invention provides a method for transacting exchanges of agricultural products. The method comprises setting a target value based on a target yield and a target price for output produced by an agricultural producer, setting a benchmark value based on a benchmark price and actual yield for the output produced by the agricultural producer. A contract value for payment of the agricultural producer is determined based on the actual yield and an actual price marketed by the agricultural producer plus a revenue adjustment in the event the target value exceeds the benchmark value.

In another embodiment, the invention provides a method for transacting exchanges of agricultural products, the method comprising setting a target yield for an agricultural producer, and setting a target price. The agricultural producer is paid no less than the target price for the target yield in exchange for purchase of inputs by the agricultural producer, delivery of output status information by the agricultural producer, and delivery of at least a portion of the output produced by the agricultural producer.

In an added embodiment, the invention provides a method for transacting exchanges of agricultural products. The method comprises setting a target yield for an agricultural product based on historic yield information, setting a target price for purchase of the agricultural product, and determining a payment for a quantity of the agricultural product based at least in part on the target price and the target yield in exchange for consideration flowing from a producer of the agricultural product to a party making the payment.

In a further embodiment, the invention provides a method for transacting exchanges of agricultural products, the method comprising setting a target value based on a target yield and a target price for output produced by an agricultural producer, setting a benchmark value based on a benchmark price and actual yield for the output produced by the agricultural producer, and paying the agricultural producer a contract value based on the actual yield and an actual price marketed by the agricultural producer plus a revenue adjustment in the event the target value exceeds the benchmark value. The payment is made provided the producer agrees to purchase inputs from a specified source, adhere to specified production conditions, deliver information to a specified entity concerning output status during the selected production season, and deliver at least a portion of the output produced by the agricultural producer to a specified outlet.

In another embodiment, the invention provides a method for transacting exchanges of agricultural products, the method comprising setting a reference value based on a target price and a reference yield for output produced by an agricultural producer, setting a target value based on a target yield for the output produced by the agricultural producer and the target price, setting a benchmark value based on a benchmark price and actual yield for the output produced by the agricultural producer, and paying the agricultural producer a contract value based on the actual yield and an actual price marketed by the agricultural producer plus a revenue adjustment in the event the target value exceeds the benchmark value subject to a maximum revenue adjustment equivalent to a portion of the reference value, provided the producer agrees to purchase inputs from a specified source, adhere to specified production conditions, deliver information to a specified entity concerning output status during the selected production season, and deliver at least a portion of the output produced by the agricultural producer to a specified outlet.

The details of one or more embodiments of the invention are set forth in the description below. Other features, objects, and advantages of the invention will be apparent from the description, and from the claims.

### BRIEF DESCRIPTION OF THE DRAWINGS

FIG. 1 is a diagram illustrating general interaction between a guarantor and an agricultural producer under a guaranteed revenue adjustment arrangement;

FIG. 2 is a diagram illustrating general interaction between a guarantor, an agricultural producer, and intermediate third parties under an arrangement for guaranteed revenue adjustment;

FIG. 3 is a flow diagram illustrating determination of guarantor liability under an arrangement for guaranteed revenue adjustment.

FIG. 4 is a flow diagram illustrating determination of guarantor liability under another arrangement for guaranteed revenue adjustment.

Like reference numbers and designations in the various drawings indicate like elements.

### DETAILED DESCRIPTION

In accordance with an embodiment of the present invention, a reduced-risk method for transacting exchanges of agricultural products such as crops makes use of a combination of different transactional characteristics to provide an agricultural producer with a guaranteed revenue adjustment. The method may involve establishment of a target value based on an expected yield and target price, a benchmark value based on actual yield and a benchmark price, and a contract value based on actual yield, actual price, the target value, and the benchmark value.

If the producer's benchmark value falls short of the target value, whether by reduction in yield or market prices, the guarantor adjusts the contract value upward by the difference. In the event the producer selects the benchmark price as the actual price to market its output, the contract value will approximate the target value, less service charges, and quality discounts, if applicable. In the event the producer seeks market pricing that is different than the benchmark price, the producer may exceed or fall below the target value. In either case, however, the producer can take advantage of the revenue adjustment to reduce overall risk.

In consideration of the guaranteed revenue adjustment, the producer agrees to certain obligations designed to benefit the guarantor and minimize the guarantor's risk. In some embodiments, such obligations may enable the guarantor to manage its risk to the extent that it may set the target value based on up to 85-95%, for example, of the expected yield for a particular output. Expected yield may refer to APH yield, historical yield, or some other measure of expected yield agreed upon by the producer and guarantor. A number of terms used herein may require general definition, as provided below.

The term “agricultural producer” may refer to an individual farmer or a large corporate farming operation. “Output” produced by the agricultural producer may take the form of crops such as corn, grain, soybeans, wheat, larger vegetables, fruit, and the like. Other outputs such as livestock, animal products, and the like, also may be suitable for an arrangement in accordance with the invention. “Inputs” purchased by the agricultural producer may include seeds, fertilizer, agricultural chemicals such as pesticides, herbicides, and fungicides, farm equipment, fuel, and the like. In the case of animal outputs, inputs may include feed, pharmaceuticals, and the like.

“Production conditions” may include the use of particular types of inputs, such as selected hybrid seeds in combination with appropriate chemicals and fertilizers. Also, the production conditions may include a crop management or “agronomic” plan that defines planting, fertilization, chemical spraying, harvest, crop storage, or other conditions that may affect the quality or yield of the producer's output.

“Output status information” may include growing information about crops in the field, such as population, crop type, growth status, estimated yield, soil conditions, and the like. Such information is sometimes referred to as crop survey information, and may result from producer reports or crop scouting visits by independent agents or agents of the guarantor. An “outlet” for a particular output may take the form of a grain elevator, processing plant, or other point of delivery for a producer's output.

The “guarantor” may be any entity that is willing to provide the guaranteed revenue adjustment. The guarantor should be able to benefit from the conditions agreed upon by the producer. In one case, the guarantor may be an integrated agricultural products provider, for example, that manufactures agricultural inputs, purchases agricultural outputs, and trades agricultural commodities and options on the open market. In some embodiments, the guarantor may be a collective entity with two or more parties that share the risk and reward associated with the revenue adjustment guarantee.

The guarantor may operate retail businesses for the agricultural inputs, as well as elevators and processing plants as outlets. In other cases, however, the guarantor may contract with third party retail businesses and outlets to handle portions of the arrangement for guaranteed revenue adjustment with the producer. Further, the guarantor may designate field agents for receipt of information from the producer.

An agreement in support of the transaction may be between the producer and the guarantor, but various components of the agreement may be provided by third parties. The third parties may have contractual obligations to the guarantor. For example, a field agent could be an independent contractor engaged by the guarantor to collect crop survey information. Also, in many cases, a retailer may act as an agent for the guarantor in obtaining subscribers to a guaranteed revenue program. Alternatively, the third parties may have no direct contractual obligation and simply operate in the ordinary course of business. As an illustration, the guarantor may specify that the producer purchase inputs from a particular retailer who happens to sell crop inputs manufactured by the guarantor.

A number of requirements imposed on the producer help reduce the guarantor's risk in making the revenue adjustment guarantee. For example, a requirement that the producer purchase agricultural inputs, such as seeds, pesticides, herbicides, fungicides, fertilizer, equipment, and fuel, from a particular retailer can produce added revenue for the guarantor or a retailer specified by the guarantor. Even if the sales are made through a retailer, the guarantor may benefit if it is the manufacturer or distributor of one or more of the inputs sold by the retailer. The retailer often will have a regional presence. For this reason, the guarantor may specify a number of different regional retailers for different producers across a larger geographic area.

A more specific requirement that the producer purchase particular inputs may increase the likelihood that the guarantor will benefit from the arrangement. In particular, the conditions may specify that the producer purchase and use inputs manufactured by the guarantor or a guarantor affiliate. In addition to revenue gains, the requirement that the producer purchase particular inputs provides added control to the guarantor, in terms of selecting higher quality inputs that are more likely to promote high yield and output quality. In other words, the guarantor benefits from input sales revenue and the greater assurance of adequate yields due to the use of such inputs. A greater assurance of adequate yields will be especially important when the guarantor is also a purchaser of the producer's outputs, and has an interest in securing sufficient quantities of the output.

A requirement that the producer deliver all or a portion of its output to an outlet specified by the guarantor can provide added stability for the guarantor, particularly when the guarantor operates the outlet or has a business relationship with the outlet. For example, the guarantor may operate processing facilities that serve as outlets, or have contracts to receive or deliver value-added products from the processing facilities. In either case, the guarantor can count on a steady supply, and perhaps negotiate discount arrangements with processing facilities for output driven to the facilities by the guarantor. In some embodiments, the producer delivers all of its output to an outlet specified by the guarantor. In other embodiments, the producer need not deliver all of its output, but may be expected to deliver a level of output commensurate with the guaranteed revenue adjustment.

A requirement that the producer deliver output status information, such as crop growth status, provides the guarantor with market information that it can use in management of risk. If the guarantor is a grain speculator, for example, knowledge of the condition of grain in the field can be very valuable. In particular, a broad base of so-called “crop scouting” information from multiple producers having similar arrangements for guaranteed revenue adjustment with the guarantor can facilitate purchase and selling decisions with respect to grain futures. Possession of output information, along with the other measures described herein and the use of conventional risk management tools, can be leveraged to produce trading profits for the guarantor.

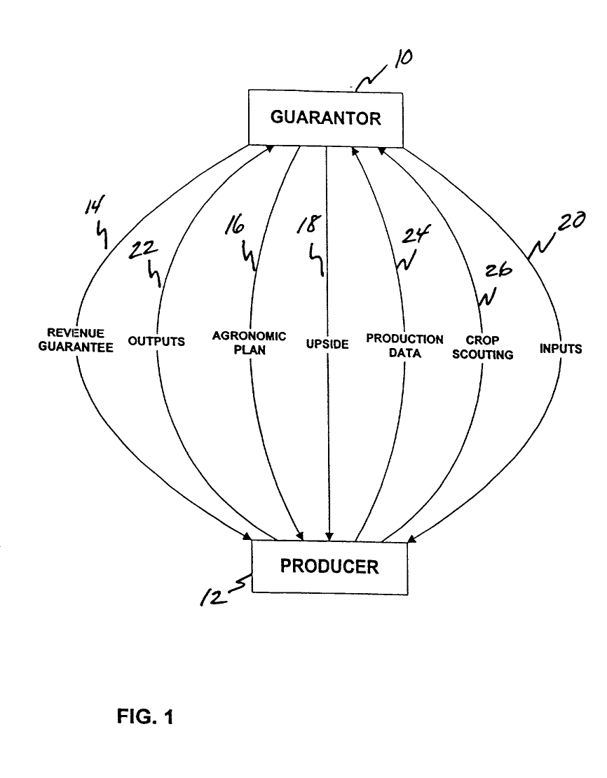

FIG. 1 is a diagram illustrating general interaction between a guarantor and an agricultural producer under an arrangement for guaranteed revenue adjustment. As shown in FIG. 1, guarantor 10 assumes liability for the revenue adjustment guarantee that is extended to producer 12, as indicated by reference numeral 14. As indicated by reference numeral 16, guarantor 10 also provides producer 12 with an agronomic plan and other counseling designed to maximize yield and minimize risk. In some cases, producer 12 may be required to adhere to the production conditions designated by the agronomic plan.

Guarantor 10 supplies agricultural inputs to producer 12, as indicated by reference numeral 20. In return, producer 12 agrees to deliver all or a substantial portion of its outputs lo guarantor 10, as indicated by reference numeral 22, and purchase all or a substantial portion of its inputs from guarantor 10, as indicated by reference numeral 20. As indicated by reference numerals 24, 26, respectively, producer 12 also provides production data to guarantor 10 and permits crop scouting by guarantor 10. As indicated by reference numeral 18, guarantor 10 permits producer 12 to keep “upside” profits in excess of the target value. In other words, if the actual revenue exceeds the target value, producer 12 keeps the difference, less service fees and quality discounts if applicable. Moreover, if the benchmark value is below the target value, the actual value is supplemented by that difference as a revenue adjustment, producing the overall contract value, again less service charges and quality discounts, if desired. Notably, the actual value is supplemented by the revenue adjustment even if the actual value exceeds the target value, providing significant upside potential to the producer. This is because the pertinent comparison for calculation of the revenue adjustment is between the benchmark value and the target value.

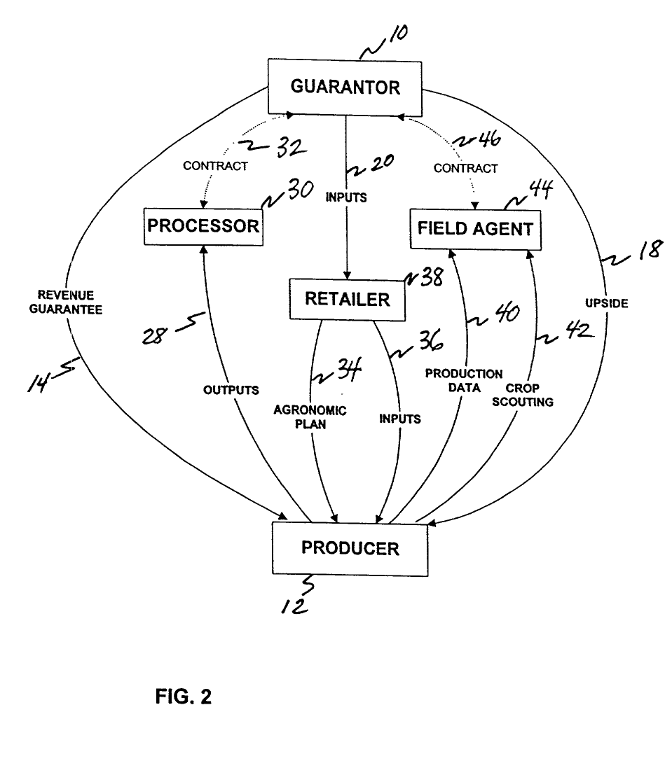

FIG. 2 is a diagram illustrating general interaction between a guarantor, an agricultural producer, and other intermediate third parties under an arrangement for guaranteed revenue adjustment. The diagram of FIG. 2 conforms substantially to that of FIG. 1, but illustrates the use of intermediate parties to fulfill certain aspects of the guarantor-producer relationship. As indicated by reference numeral 28, for example, outputs form producer 12 may be delivered to a processor 30 that is not owned or operated by guarantor 10. Instead, as indicated by reference numeral 32, processor 30 may be under contract with guarantor 10 to process the outputs.

Similarly, administration of an agronomic plan, as indicated by reference numeral 34, and delivery of inputs, as indicated by reference numeral 36, can be provided by a retailer 38. Retailer 38 may receive inputs from guarantor 10, as indicated by reference numeral 20, either via a distributor or directly. As indicated by reference numerals 40 and 42, respectively, producer 12 may provide production data and crop scouting access to a field agent 44, instead of directly to guarantor 10. Field agent 44 and guarantor 10 may have a contract, as indicated by reference numeral 46, that governs the activities of the agent and delivery of the information to the guarantor.

In arrangement for guaranteed revenue adjustment creates opportunities for retailers and producers. Retailers may act as agents for the guarantor, signing producers to the guaranteed revenue adjustment program. Once a producer reaches an agreement with the retailer, he can collaborate with the retailer to develop a crop management plan that helps meet or exceed minimum target yields. The plan could include the design of a fertility plan, chemical plan, and seed plan to achieve targeted results. The retailer then sells the required inputs to the producer. The retailer also could act as the local agent for receipt of output status information, and forward such information to the guarantor.

The guarantor pays the agricultural producer its actual value, i.e., the actual yield multiplied by the actual marketed price, plus a revenue adjustment in the event the benchmark price drops below the target price, producing the contract value. Notably, the contract value is not known until the producer locks in at an actual price. The target value can be set as a percentage of an expected yield, i.e., a target yield, multiplied by an expected or “target” price. The benchmark value can be set as the actual yield multiplied by a benchmark price. If the actual marketed price for the producer's output is the same as the benchmark price, the producer is guaranteed at least the target value, less service charges and quality discounts, if applicable.

In this manner, the guarantor pays the agricultural producer no less than the specified target price for no less than a certain percentage of the producer's expected yield, or “target yield,” for a selected production season. A level of revenue adjustment is calculated based on the target price and target yield. Although the producer ordinarily will aspire to exceed the target yield level, e.g., 85-90% of an APH, historic, or expected yield, and have confidence in its ability to market the output at favorable prices, locking in at the target price will provide an early guaranteed level of revenue that may provide advantages in obtaining financing. The revenue adjustment guarantee greatly reduces the producer's risk from both a yield and price standpoint. As described above, however, the conditions agreed upon by the producer are designed to justify the risk taken by the guarantor.

The revenue adjustment guarantee promised to the producer can be based on a minimum amount of gross income for the acreage. In particular, the guarantor and producer may set the level of target yield based on the average production history (APH) for output produced on the respective parcel or parcels of land. The APH may apply to any given period of production years, but preferably covers a minimum of five years of production. The APH will change, of course, over a number of growing seasons. The producer and guarantor may agree to disregard or weight data for anomalous years characterized by catastrophic crop damage or excessive bumper crops. Alternatively, the target yield can be set based on historical yield, or a forward-looking expected yield agreed upon by the producer and the guarantor.

In one embodiment, the guarantor preferably provides a yield guarantee of 90% of the APH, historical yield, or expected yield for the applicable acreage. This percentage of the APH, historical yield, or expected yield is the target yield. In some embodiments, higher or lower percentages, e.g., in the range of 85-95%, may be appropriate. The yield guarantee provided by the target yield is coupled with the target price. While the target yield is based on the APH, historical yield, or expected yield, the target price is set by the guarantor, the producer, or both.

For crops, the target price may be a per bushel price that is applied to the target yield to generate the guaranteed level of revenue for the acreage. Different price and quantity measures may be appropriate for different types of crops. The target price multiplied by the target yield approximates the guaranteed level of revenue in the event the producer elects to market its output at the benchmark price. This follows from the calculation of contract value as actual yield times actual price (equal to actual value) plus the difference between target value and benchmark value, less service charges and quality discounts.

At harvest time, the producer delivers the actual yield, or a substantial portion of the actual yield, to the guarantor or a specified outlet at an agreed upon market price, referred to as the actual price. The actual price may be agreed upon well in advance of harvest time based on futures prices. Actual value is calculated based on the actual price and actual yield. The revenue adjustment is calculated based on the difference between the benchmark value and the target value. If the benchmark value exceeds the target value, the producer receives only the actual value from the outlet, less any service charges or quality discounts agreed upon by the producer and guarantor. If the benchmark value drops below the target value, however, the guarantor pays the producer the actual value, less service charges and quality discounts, plus the difference between the target value and the benchmark value as a revenue adjustment. The specific amount of the revenue adjustment varies according to the benchmark value.

The revenue adjustment is based on the target value and the benchmark value, and not the actual value. Accordingly, if the producer successfully markets the output at a price that exceeds the benchmark price, or even the target price, it still receives the revenue adjustment. Similarly, even if the producer's marketing of the output is less successful, and falls below the benchmark price, it receives the same revenue adjustment. Again, if the producer elects to market the output at the benchmark price, i.e., as the actual price, the producer is guaranteed at least the target value as the contract value for the output. If the producer markets the output at a different actual price, the contract value may vary. In either case, however, the revenue adjustment is put in place to limit the producer's risk.

As an illustration, the guaranteed revenue arrangement may be viewed as having the following components: target yield, target price, actual yield, benchmark price, actual price, and calculation of the revenue adjustment. Again, the target yield is determined according to a percentage of the APH, historical yield, or expected yield for the applicable acreage. With a 90% arrangement, for example, the target yield is 90% of the APH, historical yield, or expected yield. The producer and guarantor may agree to execute the guaranteed revenue adjustment transaction for a single production season. More preferably, however, the producer and guarantor agree to multiple, e.g., two, three, or more, years of continued coverage. The target yield, target price, actual yield, benchmark price, and actual price are reset for each production season.

The target price may be determined according to one of several different options that can be elected by the producer and guarantor. According to one option, using growing year 2004 as an example, the guarantor and the producer simply use the average of December 2004 futures during the month of October 2003 as the target price. In this case, the producer has no control over the target price. Another option permits the producer to select a target price based on futures prices. For the year 2004, for example, the producer and guarantor may agree to permit the producer to select a target price from the December 2004 futures during the October 2003 to January 2004 time frame, or some other time frame agreed upon by the producer and guarantor.

According to the latter option, the guarantor and producer may agree to a pricing date on which the target price will be established. In this case, the guarantor and producer may set a pricing deadline by which the pricing date must be set by the producer, e.g., from the December 2004 futures. If the producer fails to select a pricing date by the pricing deadline, the guarantor may establish the target price. If the producer's target yield has been delivered prior to the pricing date, the target price specified by the guarantor could be based on the buyer's bid at the delivery point on the pricing date. If the target yield has not been delivered at the pricing date, the target price could be based on the buyer's bid on the pricing date for an applicable shipment period. The benchmark price may be determined in a similar manner.

Once the producer sets an actual price and delivers actual yield, calculation of loss can be performed. Calculation of loss, i.e., the revenue adjustment, and resulting payment by the guarantor is determined according to the difference between the target value and the benchmark value as follows:

(1) If (benchmark price×actual yield)<(target price×target yield), then the revenue adjustment is equal to the difference; and

(2) If (benchmark price×actual yield)>(target price×target yield), then the guarantor does not provide a revenue adjustment to the producer.

In both cases (1) and (2), the producer sells a substantial portion of the actual yield to the guarantor or a specified outlet at the actual price. Benchmark price multiplied by actual yield is the benchmark value. Target price times the target yield is the target value. Again, the target yield may be based on a percentage of APH, historical yield, or an expected yield. The benchmark and target prices may be set by the producer and guarantor. In case (1), reduced benchmark price, reduced actual yield, or a combination of both causes the producer's benchmark value to dip below the target value. In case (2), however, increased actual price, increased actual yield, or a combination of both causes the producer's benchmark value to exceed the target value.

The guarantor only pays the producer the revenue adjustment when the actual yield and the benchmark price contribute to a benchmark value that is lower than the target value. Otherwise, the producer simply takes home the actual value as the contract value. Advantageously, the producer retains any upside revenue in excess of the target value.

In one example, where the target yield is set at 90% of APH yield, the overall contract value to the producer can be calculated as follows:

Contract Value=(Actual Yield times Actual Price Marketed by Producer)−Service Charge per Bushel on First X Bushels per Acre

−Quality Discounts

+Revenue Adjustment, where:

Revenue Adjustment=Target Value−Benchmark Value,

Target Value=90% APH Yield×Target Price (e.g., December '00 Futures on Contract Date), and

Benchmark Value=Actual Yield×Benchmark Price (e.g., December '00 Futures on Agreed Upon Benchmark Date).

The number X of bushels per acre to which the service charge applies could be, for example, one-hundred bushels.

Table 1 below illustrates the revenue adjustment outcome under four different price and yield scenanos:

TABLE 1

| | Bushels/ | Price/ | Revenue/ | Guarantor Liability/ |
|---|---|---|---|---|
| | Acre | Bushel | Acre | Acre |
| Target | 90 | $2.40 | $216 | N/A |
| Benchmark 1 | 110 | $2.35 | $259 | $0 |
| Benchmark 2 | 70 | $2.10 | $147 | $69 |
| Benchmark 2 | 118 | $2.00 | $236 | $0 |
| Benchmark 3 | 65 | $3.35 | $218 | $0 |

As shown in Table 1, in scenario 1, the benchmark price of $2.35 falls below the target price of $2.40. The actual yield of 110 bushels per acre exceeds the target yield of 90 bushels per acre, however, and more than makes up for the benchmark price shortfall. In scenario 2, both benchmark price and benchmark yield are depressed relative to the targets, resulting in payout liability of $69 per acre for the guarantor as a revenue adjustment added to the producer's actual value. The sum of the actual value and the revenue adjustment is the producer's contract value.

The guaranteed revenue adjustment arrangement may include additional requirements designed to benefit both the producer and the guarantor. In some embodiments, for example, the producer and guarantor may agree that the guarantor will pay the producer a premium when the target yield, e.g., 90% of APH, or the APH is exceeded. Also, as mentioned above, the guarantor may reserve the right to apply quality discounts when the quality of the producer's output falls below applicable standards. The guarantor, in addition, may apply a per bushel service charge to a portion of the output. The service charge and quality discounts can be subtracted from the sum of the producer's actual value and any applicable revenue adjustment. The service charge and quality discounts may aid the guarantor in further reducing its risk.

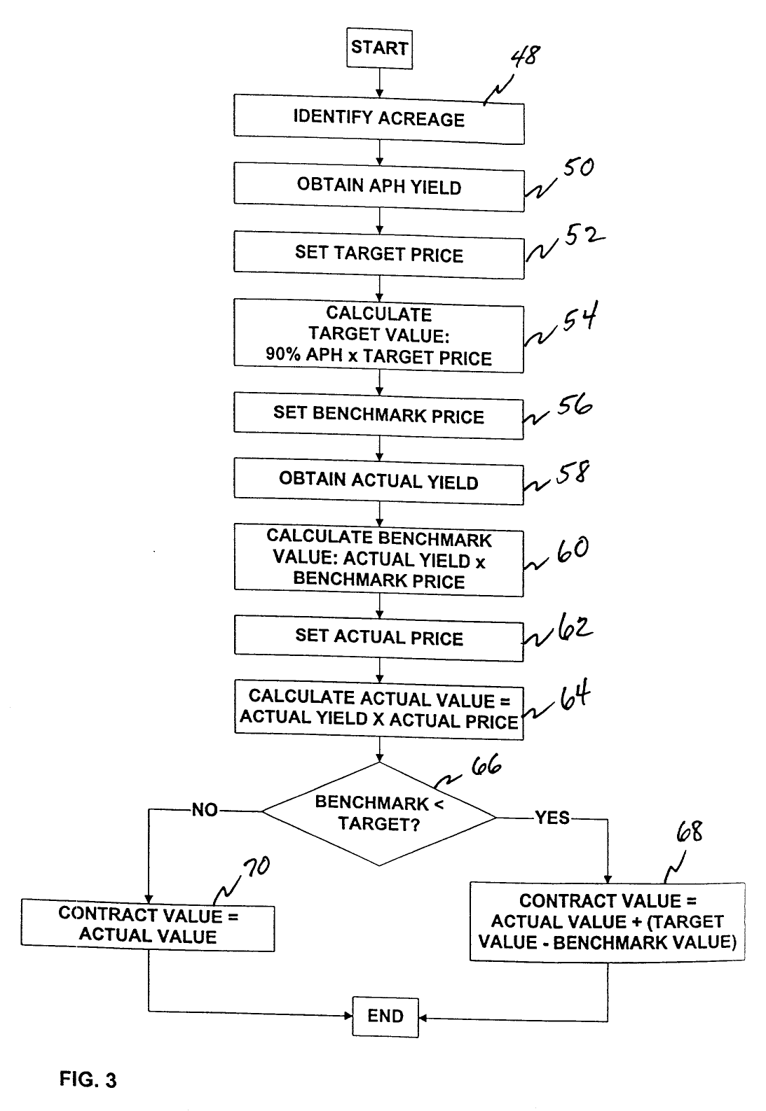

FIG. 3 is a flow diagram illustrating determination of guarantor liability under an arrangement for guaranteed revenue adjustment. As shown in FIG. 3, the producer and guarantor first identify the acreage to which the arrangement will apply, as indicated by reference numeral 48. In one embodiment, the producer then provides documentation for an agreed number of years to support an APH or historical yield, as indicated by reference numeral 50. Alternatively, the producer and guarantor may mutually agree on an expected yield based on other information.

A target price is set, as indicated by reference numeral 52, either mutually by the guarantor and producer or unilaterally by the producer, e.g., by locking in a futures price. As indicated by reference numeral 54, the target value is calculated by multiplying some percentage, e.g., 90%, of the APH times the target price. The producer then sets a benchmark price, as indicated by reference numeral 56. At harvest time, the parties determine the actual yield brought to market by the producer, as indicated by reference numeral 58, and calculate the benchmark value, as indicated by reference numeral 60. Also, the producer markets the actual yield at an actual price for the yield, as indicated by reference numeral 62.

As indicated by reference numeral 64, actual revenue is calculated by multiplying the actual yield by the actual price. The difference between benchmark value and the target value is then calculated. If the benchmark value is determined to be less than the target value, as indicated by reference numeral 66, the contract value paid to the producer by the guarantor includes a revenue adjustment. In particular, the contract value includes the actual value plus the difference between the target value and the benchmark value, as indicated by reference numeral 68.

If the benchmark value is not less than the target value, however, the contract value paid to the producer is simply the actual value, as indicated by reference numeral 70. Again, in some embodiments, the contract value may be further discounted by service charges or quality discounts, or increased on the basis of a quantity or quality bonus. Thus, if the benchmark value meets or exceeds the target value, the guarantor owes no further amounts to the producer other than the actual value. Instead, the producer enjoys a successful harvest and the actual revenue.

In some embodiments, the guarantor and producer may agree to place a limit on the revenue adjustment available to the producer. In this manner, the revenue adjustment can be focused on the revenue that is ordinarily most critical to farming profitability, i.e., the “working layer.” Producers usually do not experience revenue decreases of more than twenty-five percent. Many producers may experience, however, revenue decreases in the range of ten to twenty percent. In this “working layer” of revenue, the producer's income is most vulnerable. The invention can be more narrowly tailored to address this concern by setting a maximum revenue adjustment that reflects coverage for a certain percentage of a reference value determined according to a target price and an APH, historic, or expected yield.

For example, in some embodiments, the invention can be formulated to provide protection in the range of X to Y percent of the reference value. As an example, the range could be 75-90% of the reference value. In this example, the revenue adjustment available to the producer has a maximum value of 15 percent of the reference value. Other percentage ranges may be used according to the characteristics of the specific arrangement established between the producer and guarantor. Accordingly, a range of 75-90% should not be considered limiting of the invention as broadly embodied herein. The reference value serves as the basis for calculation of the maximum revenue adjustment. Thus, the payment to the producer is calculated based on the reference yield, target yield, target price, benchmark price, actual yield, and maximum revenue adjustment.

Again, the reference yield (bushels/acre) for the reference value can be determined by APH, historic yield, or expected yield information agreed upon by the guarantor and producer. In one example, the target yield is determined to be 90% of the reference yield. The target value is then the product of target price multiplied by the target yield, e.g., 90% APH in the event APH is used for the reference yield. However, a maximum revenue adjustment is calculated, e.g., as 15% of the reference value. The reference value is the product of the target price multiplied by the reference yield, e.g., 100% APH in the event APH is used for the reference yield.

As an example, it is assumed that a given producer has a reference yield of 150 bushels/acre, which may be derived from the APH for a specific parcel farmed by the producer. For a target price of $2.50, the producer has a reference value of $375.00 (150 bushels/acre×$2.50/bushel). The target value for the producer is the target yield (90% of the reference yield, or 135 bushels/acre) times the target price, and is equal to $337.50 (135 bushels/acre×$2.50/bushel). In this case, the maximum revenue adjustment is 15% of the reference value, which equals $56.25 (0.15×$375.00). In this manner, the maximum revenue adjustment protects the producer's revenue between 75% and 90% of the reference value, which represents the critical profitability range for most growing seasons.

In this example, the overall contract value to the producer can be calculated as follows:

Contract Value=(Actual Yield times Actual Price Marketed by Producer)−Service Charge per Bushel on First X Bushels per Acre−Quality Discounts+Revenue Adjustment,

where:

Revenue Adjustment=Target Value−Benchmark Value, but is no greater than 15% Reference Value, where

Target Value=90% APH Yield×Target Price (e.g., December '00 Futures on Contract Date),

Benchmark Value=Actual Yield×Benchmark Price (e.g., December '00 Futures on Agreed Upon Benchmark Date), and

Reference Value=APH Yield×Target Price (e.g., December '00 Futures on Contract Date).

Table 2 below illustrates a market scenario according to an embodiment of the invention in which the producer and guarantor agree to a maximum revenue adjustment.

TABLE 2

| | Bushels/ | Price/ | Revenue/ | Guarantor Liability/ |
|---|---|---|---|---|
| | Acre | Bushel | Acre | Acre |
| Target | 135 | $2.50 | $337.50 | N/A |
| Benchmark 1 | 140 | $2.10 | $294.00 | $43.50 |
| Benchmark 2 | 120 | $2.35 | $282.00 | $55.50 |
| Benchmark 3 | 110 | $2.20 | $242.00 | $56.25 |
| Benchmark 4 | 105 | $3.42 | $359.10 | $0 |
| Benchmark 5 | 175 | $1.95 | $341.25 | $0 |

In the example illustrated by Table 2, the guarantor's liability to the producer is capped by the maximum revenue adjustment, which is equal to 15% of the reference value. In benchmark scenarios 1 and 2, the guarantor pays the producer a revenue adjustment equal to the difference between the benchmark value and the target value, both reflected in the “Revenue/Acre” columns of Table 2. Benchmark scenario 1 is characterized by average yields (140 bushels/acre) and low prices ($2.10/bushel). Benchmark scenario 2 is characterized by low yields and average prices.

Benchmark scenario 3 is characterized by both low yields and low prices. In benchmark scenario 3, the revenue adjustment is capped at the maximum revenue adjustment of $56.25, which is substantially less than the difference between the target and benchmark values of $95.50. Thus, the guarantor is liable for a revenue adjustment in benchmark scenario 3, but the liability is limited to the maximum revenue adjustment.

In benchmark scenarios 4 and 5, the benchmark value exceeds the target value. As a result, the guarantor has no liability to the producer for a revenue adjustment in benchmark scenarios 4 and 5. Benchmark scenario 4 is characterized by low yields but high prices, whereas benchmark scenario 5 is characterized by high yields which offset low prices.

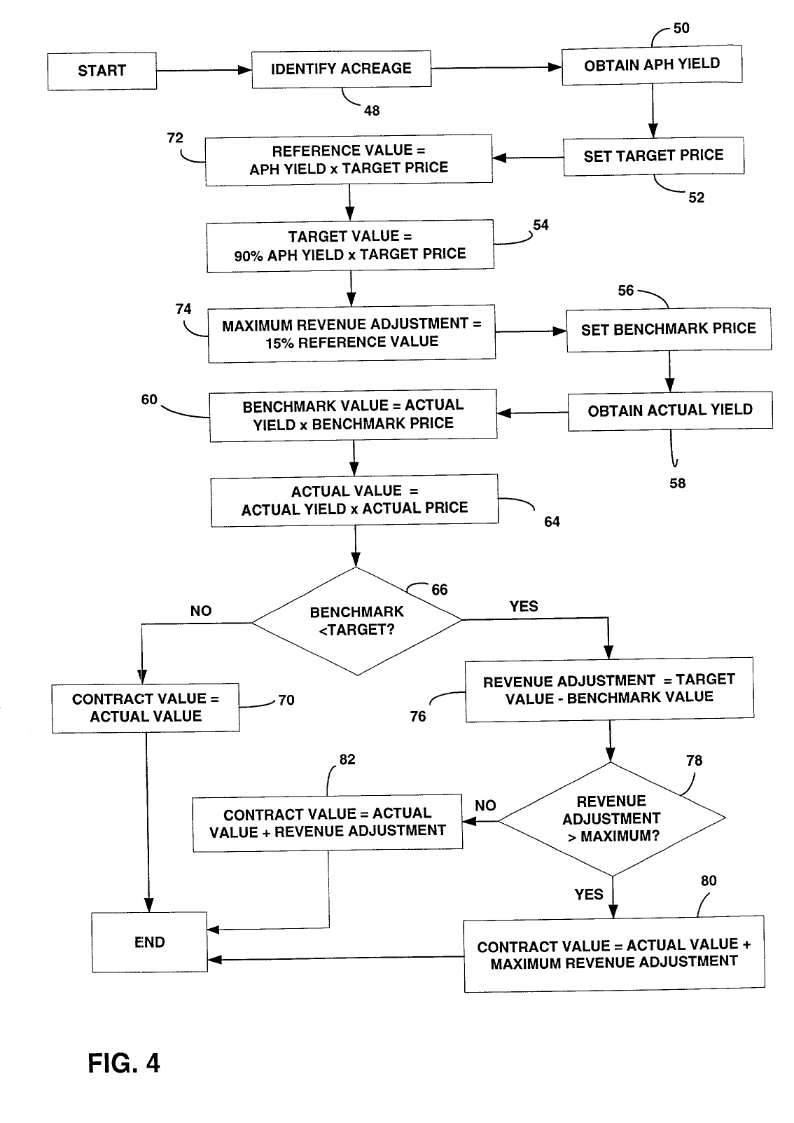

FIG. 4 is a flow diagram illustrating determination of guarantor liability under an arrangement for guaranteed revenue adjustment in which the revenue adjustment is subject to a maximum. The process shown in FIG. 4 conforms substantially to that of FIG. 3, but further includes the determination of a maximum revenue adjustment. Like reference numerals are used for certain functions shown in both FIG. 3 and FIG. 4. As shown in FIG. 4, the producer and guarantor first identify the acreage to which the arrangement will apply, as indicated by reference numeral 48. In one embodiment, the producer then provides documentation for an agreed number of years to support an APH or historical yield, as indicated by reference numeral 50. Alternatively, the producer and guarantor may mutually agree on an expected yield based on other information.

A target price is set, as indicated by reference numeral 52, either mutually by the guarantor and producer or unilaterally by the producer, e.g., by locking in a futures price. As indicated by reference numeral 72, a reference value is calculated based on the APH yield and the target price. The target value is then calculated by multiplying some percentage, e.g., 90%, of the APH times the target price, as indicated by reference numeral 54. As indicated by reference numeral 74, a maximum revenue adjustment is calculated as a percentage of the reference value. The producer then sets a benchmark price, as indicated by reference numeral 56.

At harvest time, the parties determine the actual yield brought to market by the producer, as indicated by reference numeral 58, and calculate the benchmark value, as indicated by reference numeral 60. Also, the producer markets the actual yield at an actual price for the yield. As indicated by reference numeral 64, actual revenue is calculated by multiplying the actual yield by the actual price. The difference between benchmark value and the target value is then calculated. If the benchmark value is determined to be less than the target value, as indicated by reference numeral 66, the contract value paid to the producer by the guarantor includes a revenue adjustment. In this embodiment, however, the revenue adjustment is subject to the maximum revenue adjustment.

The revenue adjustment is equivalent to the difference between the target value and the benchmark value, as indicated by reference numeral 76. If the resulting revenue adjustment is determined to be greater than or equal to the maximum, as indicated by reference numeral 78, the contract value is the actual value plus the maximum revenue adjustment, as indicated by reference numeral 80. If the revenue adjustment is less than the maximum revenue adjustment, the contract value is the actual value plus the calculated revenue adjustment, as indicated by reference numeral 82. If the benchmark value is greater than the target value, the contract value is simply the actual value, as indicated by reference numeral 70.

A number of embodiments of the present invention have been described. Nevertheless, it will be understood that various modifications may be made without departing from the spirit and scope of the invention. In particular, the target yield percentages and other ranges described herein are for purposes of illustration and should not be considered limiting of the invention as broadly embodied in this detailed description. Accordingly, other embodiments are within the scope of the following claims.

1. A method for transacting exchanges of agricultural products, the method comprising:
setting a target value based on a target yield and a target price for output produced by an agricultural producer;
setting a benchmark value based on a benchmark price and actual yield for the output produced by the agricultural producer; and
determining a contract value for payment of the agricultural producer based on the actual yield and an actual price marketed by the agricultural producer plus a revenue adjustment in the event the target value exceeds the benchmark value.

2. The method of claim 1, further comprising paying the contract value to the agricultural producer and, in consideration of the payment, requiring that the producer:
purchase inputs from a specified source,
adhere to specified production conditions,
deliver information to a specified entity concerning output status during the selected production season, and
deliver at least a portion of the output produced by the agricultural producer to a specified outlet.

3. The method of claim 2, wherein the specified source, the specified entity, and the specified outlet are a common entity.

4. The method of claim 2, wherein one or more of the specified source, the specified entity, and the specified outlet are agents of a common entity.

5. The method of claim 2, wherein the inputs include seed, agricultural chemicals, and fertilizer.

6. The method of claim 2, wherein the production conditions include specified types of seed, agricultural chemicals, and fertilizer.

7. The method of claim 2, wherein the information concerning production conditions includes crop growth conditions at one or more times during the selected production season.

8. The method of claim 2, wherein the output includes a crop.

9. The method of claim 2, further comprising requiring that the producer deliver at least the portion of the output produced by the agricultural producer to the specified outlet over two or more production seasons.

10. The method of claim 1, further comprising calculating the revenue adjustment based on a difference between the target value and the benchmark value.

11. The method of claim 1, further comprising determining a maximum revenue adjustment.

12. The method of claim 11, further comprising:
determining the revenue adjustment based on the difference between the target value and the benchmark value; and
in the event the revenue adjustment exceeds the maximum revenue adjustment, determining the contract value based on the actual yield and the actual price marketed by the agricultural producer plus the maximum revenue adjustment.

13. The method of claim 12, further comprising determining the maximum revenue adjustment by:
setting a reference value for the output produced by the agricultural producer based on the target price and a reference yield for the output;
setting the maximum revenue adjustment based on a percentage of the reference value.

14. The method of claim 13, further comprising determining the reference yield based on one of average production history (APH) information, historical yield information, and expected yield information agreed upon with the producer.

15. The method of claim 1, further comprising determining the target yield based on one of average production history (APH) information, historical yield information, and expected yield information agreed upon with the producer.

16. The method of claim 1, wherein the target yield is at least approximately 90% of an average production history (APH) yield for the output.

17. The method of claim 1, wherein the target yield is at least approximately 90% of a historical yield for the output.

18. The method of claim 1, wherein the target yield is based on approximately 90% of an expected yield agreed upon with the producer for the output.

19. The method of claim 1, further comprising setting the target price based on a futures price for the output.

20. The method of claim 1, wherein the output includes a crop.

21. The method of claim 1, further comprising adjusting the contract value based on service fees and discounts applied to the agricultural producer.

22. A method for transacting exchanges of agricultural products, the method comprising:
setting a target yield for an agricultural producer;
setting a target price; and
paying the agricultural producer no less than the target price for the target yield in exchange for purchase of inputs by the agricultural producer, delivery of output status information by the agricultural producer, and delivery of at least a portion of the output produced by the agricultural producer.

23. The method of claim 22, wherein the inputs include seed, agricultural chemicals, and fertilizer.

24. The method of claim 22, wherein the output status information includes crop growth conditions at one or more times during the selected production season.

25. The method of claim 22, wherein the output includes a crop, and the target yield is 75 to at least 90% of an average production history (APH) yield for the crop by the agricultural producer.

26. The method of claim 22, wherein the payment is made further in exchange for delivery of at least the portion of the output produced by the agricultural producer to a specified outlet over two or more production seasons.

27. The method of claim 22, wherein paying includes paying the agricultural producer either (a) the target price for the target yield, or (b) a market price for the target yield, whichever is greater.

28. The method of claim 27, further comprising paying the agricultural producer at least the target price for the target yield for two or more selected production seasons.

29. The method of claim 27, further comprising setting the target price based on a futures price for the output.

30. The method of claim 22, further comprising paying the agricultural producer at least the target price for the target yield for two or more selected production seasons.

31. A method for transacting exchanges of agricultural products, the method comprising:
setting a target yield for an agricultural product based on historic yield information;
setting a target price for purchase of the agricultural product; and
determining a payment for a quantity of the agricultural product based at least in part on the target price and the target yield in exchange for consideration flowing from a producer of the agricultural product to a party making the payment.

32. The method of claim 31, wherein determining the payment includes determining the payment in exchange for agreement by the producer to adhere to one or more specified conditions.

33. The method of claim 32, wherein the specified conditions include at least one of purchase of agricultural inputs by the agricultural producer from a specified source, adherence by the agricultural producer to specified production conditions, delivery of information by the agricultural producer to a specified entity concerning product growth status during a selected production season, and delivery of at least a portion of the product produced by the agricultural producer to a specified outlet.

34. The method of claim 32, further comprising paying an agricultural producer either (a) the determined payment, or (b) a payment based on market price for the target yield, whichever is greater.

35. A method for transacting exchanges of agricultural products, the method comprising:
setting a target value based on a target yield and a target price for output produced by an agricultural producer;
setting a benchmark value based on a benchmark price and actual yield for the output produced by the agricultural producer; and
paying the agricultural producer a contract value based on the actual yield and an actual price marketed by the agricultural producer plus a revenue adjustment in the event the target value exceeds the benchmark value provided the producer agrees to:
purchase inputs from a specified source,
adhere to specified production conditions,
deliver information to a specified entity concerning output status during the selected production season, and
deliver at least a portion of the output produced by the agricultural producer to a specified outlet.

36. A method for transacting exchanges of agricultural products, the method comprising:
setting a reference value based on a target price and a reference yield for output produced by an agricultural producer;
setting a target value based on a target yield for the output produced by the agricultural producer and the target price;
setting a benchmark value based on a benchmark price and actual yield for the output produced by the agricultural producer; and
paying the agricultural producer a contract value based on the actual yield and an actual price marketed by the agricultural producer plus a revenue adjustment in the event the target value exceeds the benchmark value subject to a maximum revenue adjustment equivalent to a portion of the reference value, provided the producer agrees to:
purchase inputs from a specified source,
adhere to specified production conditions,
deliver information to a specified entity concerning output status during the selected production season, and
deliver at least a portion of the output produced by the agricultural producer to a specified outlet.
